(19) United States
(12) Patent Application Publication
(10) Pub. No.: US 2016/0146353 A1
(43) Pub. Date: May 26, 2016

(54) BOOT UNIT AND MANUFACTURING METHOD THEREOF

(71) Applicants: Hyundai Motor Company, Seoul (KR); Kia Motors Corporation, Seoul (KR); Hyundai WIA Corporation, Changwon-si (KR); KD A&T Co., Ltd., Incheon (KR)

(72) Inventors: Won Jun CHOI, Yangsan-si (KR); Yong Jin KIM, Gwangmyeong-si (KR); Hyangcheol JO, Suwon-si (KR); Kwangduck HER, Incheon (KR)

(73) Assignees: Hyundai Motor Company, Seoul (KR); Kia Motors Corporation, Seoul (KR); Hyundai WIA Corporation, Changwon-si (KR); KD A&T Co., Ltd., Incheon (KR)

(21) Appl. No.: 15/009,282

(22) Filed: Jan. 28, 2016

Related U.S. Application Data
(62) Division of application No. 14/074,600, filed on Nov. 7, 2013.

(30) Foreign Application Priority Data
Nov. 8, 2012 (KR) 10-2012-0126229

(51) Int. Cl. F16J 15/52; B29C 45/16; B29C 45/14

(52) U.S. Cl. CPC F16J 15/52; B29C 45/14; B29C 45/1671; B29L 2031/26

(57) ABSTRACT

A boot unit may comprise a boot that includes a small diameter portion formed at one side, a large diameter portion form at the other side, and a wrinkle portion formed between the small diameter portion and the large diameter portion, a bushing that is integrally formed with an interior circumference or an exterior circumference in a circumferential direction and having a predetermined thickness, and a band that is formed in the bushing along the circumferential direction of the bushing and has substantially a ring shape.

### CROSS-REFERENCE TO RELATED APPLICATION

The present application claims priority of Korean Patent Application Number 10-2012-0126229 filed Nov. 8, 2012, the entire contents of which application are incorporated herein for all purposes by this reference.

### BACKGROUND OF INVENTION

1. Field of Invention

The present invention relates to a boot unit that is mounted on a power delivery device of a vehicle to prevent inner side lubricant from leaking and prevent foreign material from permeating.

2. Description of Related Art

A boot is a cover of rubber material to cover a part of a master cylinder, a wheel cylinder, a cable, an electric wire, or a connector, and can be applied to a constant velocity joint of a vehicle.

The boot unit for a vehicle is applied to a part that is connected to a constant velocity joint or a connection part of rotation shafts to prevent oil/grease from leaking out or prevent pollution material from permeating.

General boot unit for a vehicle includes a boot that is disposed between shafts to sustain air-tightness and a band for fixing the boot thereon. In this configuration, one side of the boot is fixed by one band, and the other side of the boot is fixed by the other band.

Meanwhile, there are drawbacks in that the boot and the band are separately dealt, and the band has to be accurately mounted on the boot after mounting the boot.

Further, an exterior diameter of the boot can be increased by covering the band on an exterior side of the boot, and the boot unit can be interfered by adjacent components. In addition, the boot and the band can be separated or detached such that overall durability and sealing performance can be deteriorated.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide a boot unit and the manufacturing method having advantages of improving the durability and the sealing performance by improving the engaging structure of a boot and a band, reducing the exterior diameter of the boot unit, preventing the interference with adjacent components, and preventing the separation or the detachment of the boot and the band.

A boot unit according to various aspects of the present invention may include a boot that includes a small diameter portion formed at one side, a large diameter portion form at the other side, and a wrinkle portion formed between the small diameter portion and the large diameter portion, a bushing that is integrally formed with an interior circumference or an exterior circumference in a circumferential direction and having a predetermined thickness, and a band that is formed in the bushing along the circumferential direction of the bushing and has substantially a ring shape.

The band may include a band ear that protrudes from an exterior circumference of the band, and a groove portion may be formed on the boot and the busing such that the band ear is exposed to an outside of the boot through the groove portion.

The boot and the bushing may be chemically integrally formed or boned with each other. The bushing may be formed along an interior circumference of the large diameter portion of the boot.

A cover portion may be integrally formed with the bushing to protect an end portion surface of the large diameter portion of the boot. The bushing may be molded on the large diameter portion of the boot and the band may be formed inside the busing by an insert molding method.

A method for manufacturing a boot unit according to various aspects of the present invention may include forming a boot that includes a large diameter portion, and integrally forming a bushing with the large diameter portion of the boot by molding the boot with the bushing using an over mold method, wherein the integrally forming a bushing includes inserting a band into the bushing.

In the integrally forming a bushing, the boot and the bushing may be chemically integrally formed or bonded with each other. The cover portion may be integrally formed thereon in a radial direction so as to protect an end surface of the large diameter portion of the boot

A boot unit according to various other aspects of the present invention may include a bushing that includes an one side exterior circumference formed at one side thereof, an other side exterior circumference formed at the other side thereof, and a step surface formed between the one side exterior circumference and the other side exterior circumference, wherein a distance of the other side exterior circumference from a central axis is smaller than that of the one side exterior circumference from the central axis, a boot that includes a small diameter portion formed at one side, a large diameter portion formed at the other side, a wrinkle portion formed between the small diameter portion and the large diameter portion, wherein the large diameter portion has a diameter that is larger than the small diameter portion and an interior circumference that is integrally formed with the one side exterior circumference, the step surface, and the other side exterior circumference of the bushing, and a band that is configured to have the boot contact the bushing.

The boot unit may further include an end portion cover portion that is integrally formed with an end portion of the bushing to be extended in a radial direction, and an outside cover portion that is integrally formed with an end portion of the end portion cover portion to correspond to the other side exterior circumference of the bushing, wherein the band contacts an exterior circumference of the outside cover portion to fix the outside cover portion on an exterior circumference of the boot and fix the boot on the other side exterior circumference of the bushing.

The bushing may be molded with the large diameter portion of the boot using an over mold method, in which the large diameter portion of the boot is inserted into a mold and a molding material is injected or inserted into the mold to form the bushing.

In various aspects of the present invention, a band is disposed inside a bushing, and therefore there is effectiveness for reducing maximum diameter of a boot unit.

Also, when a busing is formed using an over molding method on an interior circumference of a large diameter portion of a boot, a band is inserted into the mold to reduce a danger that a band is separated by an external interference.

Further, a combination force between a band and a busing is improved to improve overall durability and rigidity. In addition, a boot and a busing are chemically combined to improve the combination force between them, and a boot, a busing, and a band can be dealt as one integrally formed component.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic perspective view of an exemplary boot unit in an exemplary power delivery device according to the present invention.

FIG. 2 is a perspective view of an exemplary boot unit according to the present invention.

FIG. 3 is a lengthwise direction cross-sectional view of an exemplary boot unit according to the present invention.

FIG. 4 is a perspective view of an exemplary boot of a boot unit according to the present invention.

FIG. 5 is a perspective view of an exemplary busing and an exemplary band of a boot unit according to the present invention.

FIG. 6 is a perspective view showing an exemplary busing and an exemplary band of a boot unit that are engaged by an insert molding process according to the present invention.

FIG. 7 is a flowchart showing an exemplary method for manufacturing a boot unit according to the present invention.

FIG. 8 is a cross-sectional view showing a lengthwise direction cross-section of another exemplary boot unit according to the present invention.

FIG. 9 is a perspective cross-sectional view showing a section of another exemplary bushing of a boot unit according to the present invention.

FIG. 10 is a cross-sectional view showing an engagement structure of another exemplary bushing and another exemplary boot of a boot unit according to the present invention.

FIG. 11 is a partial cross-sectional view showing another exemplary band engaged in a boot unit according to the present invention.

FIG. 12 is a partial cross-sectional view showing another exemplary band fastened on a boot unit according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

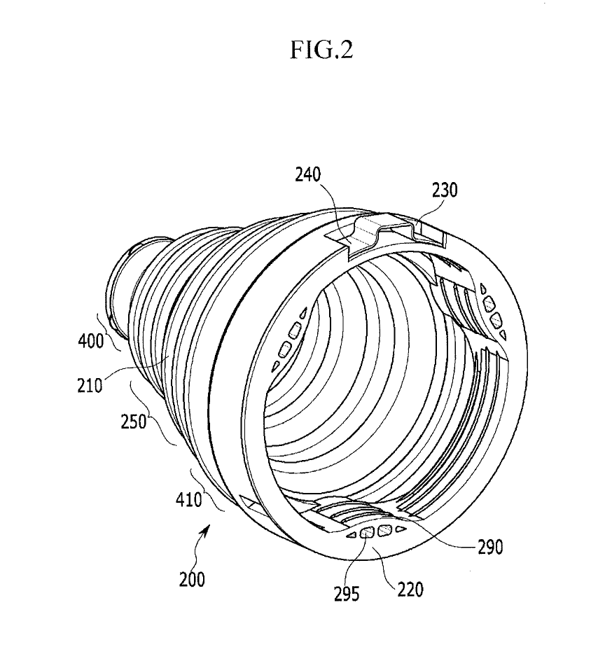

FIG. 2 is a perspective view of a boot unit according to various embodiments of the present invention. Referring to FIG. 2, a boot unit 200 includes a boot 250, a bushing 220, and a band 230.

A wrinkle portion 210 is formed between a small diameter portion 400 and a large diameter portion of the boot 250 and a busing 220 having a predetermined thickness is formed on an interior circumference of the large diameter portion 410.

Further, the band 230 is formed in the bushing 220 in a circumferential direction of the bushing 220. A groove portion 280 is formed at one side of the large diameter portion 410 of the boot 250, and the band 230 is exposed through the groove portion 280. A band ear 240 protrudes out of an exterior circumference of the band 230, and the band ear 240 is formed to correspond to the groove portion 280.

A user uses the band ear 240 of the band 230 to fix the busing 220 on an exterior circumference of a power delivery device, for example, by any suitable or conventional methods, and the detailed description thereof will be omitted.

A mounting protrusion 290 is convexly formed on an interior circumference of the bushing 220, and the mounting protrusion 290 is seated in a groove that corresponds to the mounting protrusion 290 such that the boot unit 200 is securely fixed. A hole 295 is formed in the mounting protrusion 290, and the hole 295 provides elastic force when the mounting protrusion 290 is mounted and reduces overall weight.

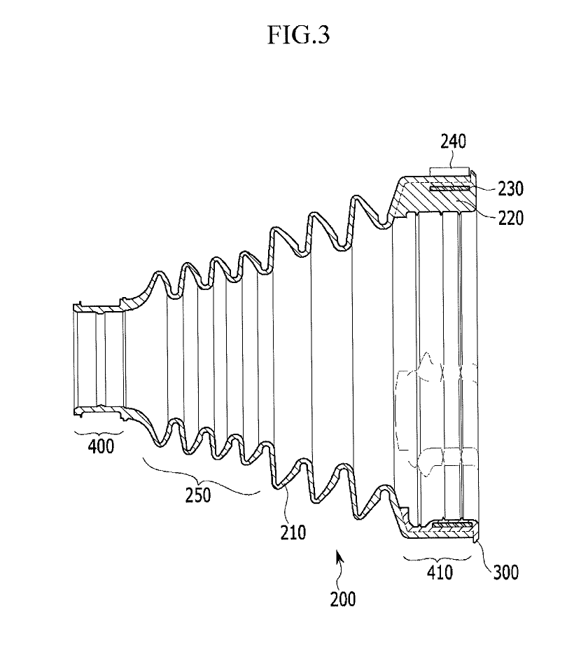

FIG. 3 is a lengthwise direction cross-sectional view of a boot unit according to various embodiments of the present invention. Referring to FIG. 3, the bushing 220 is formed on an interior circumference of the large diameter portion 410 of the boot 250 by a predetermined thickness, and the band 230 is disposed inside the boot 250. Particularly, the band 230 is disposed inside the bushing 220 except the groove portion 280.

The interior circumference of the large diameter portion 410 of the boot 250 and the bushing 220 are substantially integrally formed. One will appreciate that the large diameter, bushing and boot may be monolithically formed. Particularly, they have chemically continuous structure to be integrally formed. Further, the band 230 is fixedly disposed within the bushing 220 by an insert molding process when the bushing 220 is molded, wherein the over mold process (method) is that the large diameter portion of the boot is inserted into a mold and molding material is injected or inserted into the mold to form the bushing.

A cover portion 300 is formed on the busing 220 to cover an outside end portion surface of the large diameter portion 410. The cover portion 300 securely keeps the connection of the boot 250 and the bushing 220 and protects an outside end portion of the boot 250. Here, the cover portion 300 can be continuously or intermittently formed along a circumferential direction of the bushing 220.

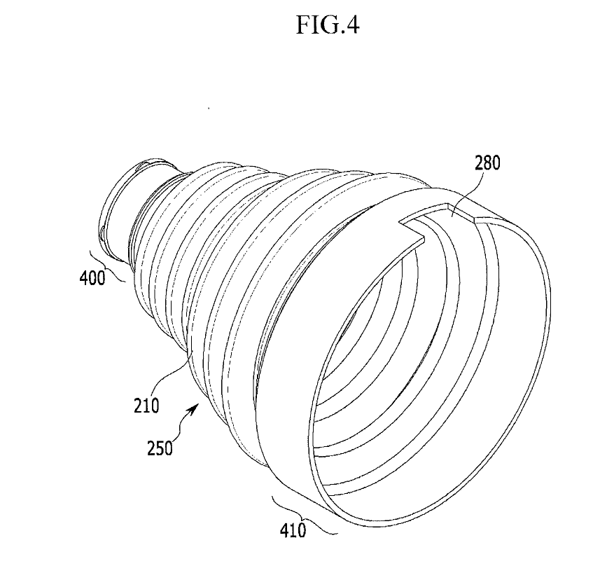

FIG. 4 is a perspective view of a boot of a boot unit according to various embodiments of the present invention. Referring to FIG. 4, the boot 250 includes a small diameter portion 400, a wrinkle portion 210, and a large diameter portion 410 that are disposed in a lengthwise direction, and the large diameter portion 410 is incised to form the groove portion 280. The boot 250 can be formed, for example, by a blowing method, including any suitable conventional blowing methods.

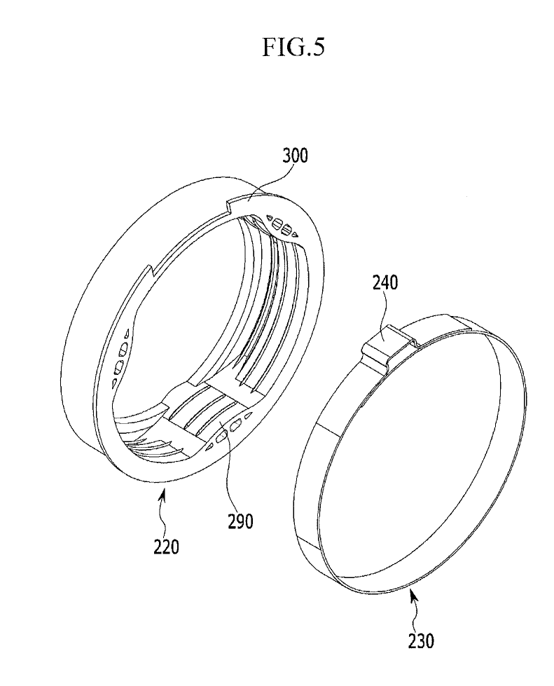

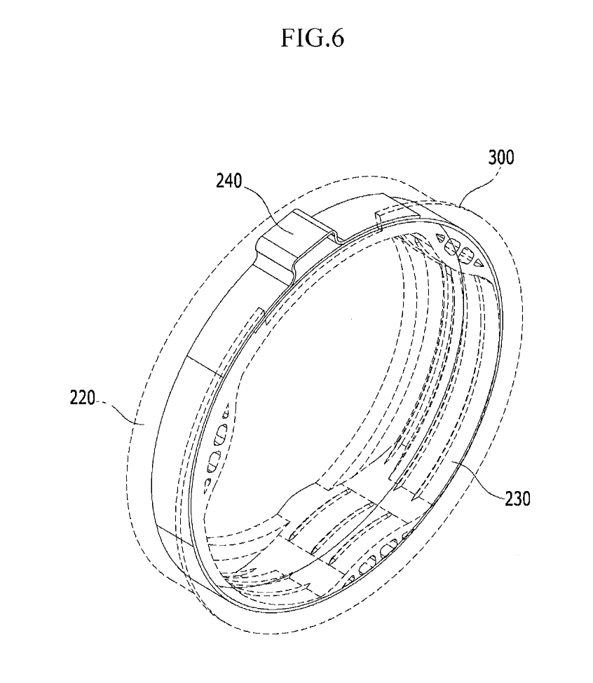

FIG. 5 is a perspective view of a busing and a band of a boot unit according to various embodiments of the present invention, and FIG. 6 is a perspective view showing a busing and a band of a boot unit that are engaged, for example, by an insert molding process according to various embodiments of the present invention.

Referring to FIG. 5 and FIG. 6, a metal plate member having a predetermined length and width is bent, both ends are combined to form a substantially ring shape band 230, and a band ear 240 protrudes out of one side of the exterior circumference.

The band 230 is disposed in a mold that is used to form the busing 220 such that the band 230 is disposed in the busing 220, wherein the over mold method is that the large diameter portion of the boot and the band are inserted into a mold and molding material is injected or inserted into the mold to form the bushing. Further, the band ear 240 is exposed to an outside through the groove portion 280.

Further, as described above, a convex mounting protrusion 290 is formed on an interior circumference of the busing 220 and a cover portion 300 is formed at one side end portion along a circumferential direction.

In the present invention, the band 230 is disposed inside the bushing 220 such that a max or overall diameter of the boot 250 is reduced.

If a metal band were disposed on an exterior circumference of the busing 220 or the boot 250, the max or overall diameter of the boot 250 would be increased by a band ear. By disposing the band 230 inside the bushing 220, the overall diameter of the boot 250 equals to the diameter of the large diameter portion 410, and would not be increased by the band ear.

Further, when the busing 220 is formed by an over mold method on an interior circumference of the large diameter portion 410 of the boot 250, the band 230 is inserted into a mold to reduce the danger of the band that can be separated from the busing 220 by an outside interference. In addition, combining or bonding force between the band 230 and the bushing 220 is improved and overall durability and stability are also improved.

Further, when the bushing 220 is formed on an interior circumference of the large diameter portion 410 of the boot 250, the boot 250 and the busing 220 are substantially chemically integrally formed to improve the combining or bonding force and the boot 250, the bushing 220, and the band 230 can be managed or considered as one component that is integrally and/or monolithically formed.

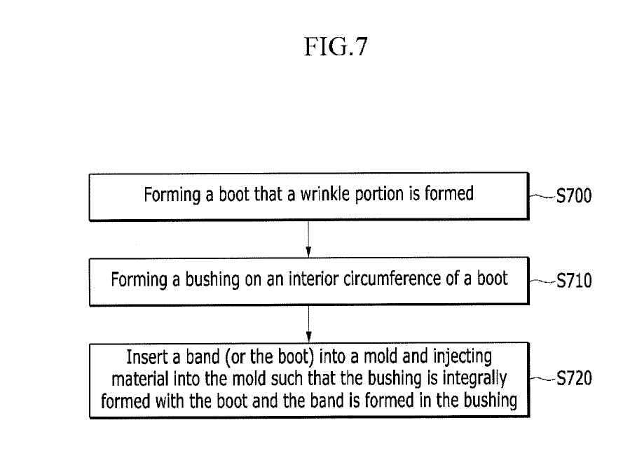

FIG. 7 is a flowchart showing an exemplary method for manufacturing a boot unit according to the present invention. Referring to FIG. 7, a S700 is a step in which the boot 250 having a small diameter portion 400, a large diameter portion 410, and a wrinkle portion 210 is formed, for example, by a blow process.

A S710 is a step in which the busing 220 is made, for example, by an over molding method on the large diameter portion 410 of the boot 250. Here, the S720 can be performed during the S710. That is, the band 230 is inserted in a mold when the bushing 220 is molded by an over mold method.

By way of illustration, the above S700, S710, and S720 are sequentially arranged for convenience of explanation. However, the order of these steps does not necessarily need to be sequential, and in some cases, it can be randomly set or they can be simultaneously performed.

By way of illustration, it is described above that the bushing 220 and the band 230 are applied to the large diameter portion 410 of the boot 250. In various other embodiments, the bushing 220 and the band 230 can be applied to the small diameter portion 400 of the boot 250 using the same method.

Further, by way of illustration, it is described above that the busing 220 is formed by an over mold method together with the boot 250. In various other embodiments, the boot 250 can have a predetermined thickness such that the boot 250 can perform the function of the busing. In such embodiments, the band 230 is disposed inside the thickened portion of the boot 250.

In various embodiments of the present invention, the boot and the bushing can be made of rubber, plastic, or resin material, and the band can be made of metal material.

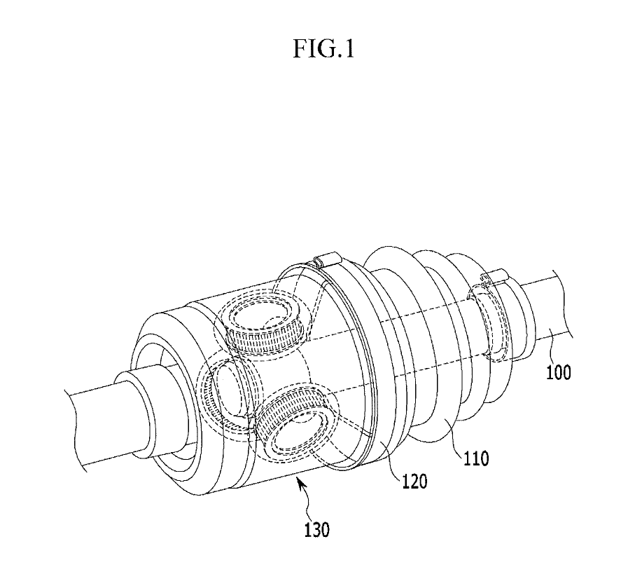

FIG. 1 is a schematic perspective view of a boot unit applied to a power delivery device according to various embodiments of the present invention. Referring to FIG. 1, a power delivery includes a constant velocity joint 130, a band 120, a boot 110, and a driveshaft 100. And, the boot unit includes the boot 110 and the band 120.

The constant velocity joint 130 uses a joint structure and a ball to transmit a torque of the drive shaft 100 to a rear side shaft. The structure of the constant velocity joint 130 is known, and therefore the detailed description thereof will be omitted.

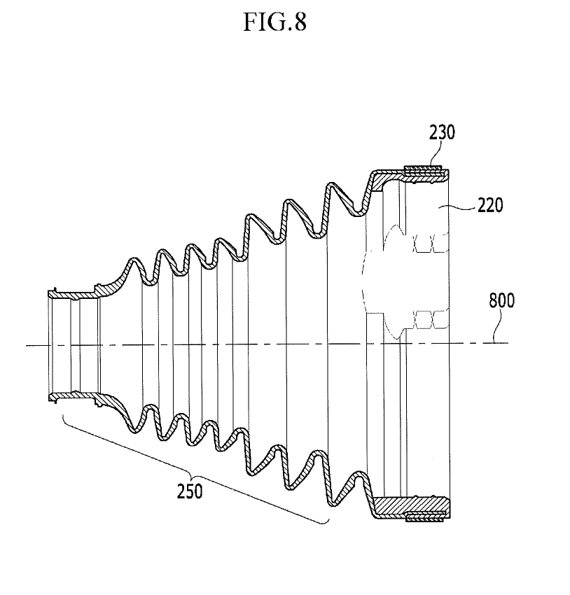

FIG. 8 is a cross-sectional view showing a lengthwise direction cross-section of a boot unit according to various other embodiments of the present invention. Referring to FIG. 8, a boot unit 200 includes a boot 250, a bushing 220, and a band 230.

The boot 250 is disposed on a central axis, and the bushing 220 contacts an exterior circumference and an interior circumference of the large diameter portion of the boot 250. The bushing 220 and the boot 250 are formed using, for example, an over-mold method, to be integrally formed. Accordingly, the separation thereof is prevented. Further, the band 230 has the bushing 220 and the boot 250 closely contacted to safely fix them on an exterior circumference of a constant velocity joint.

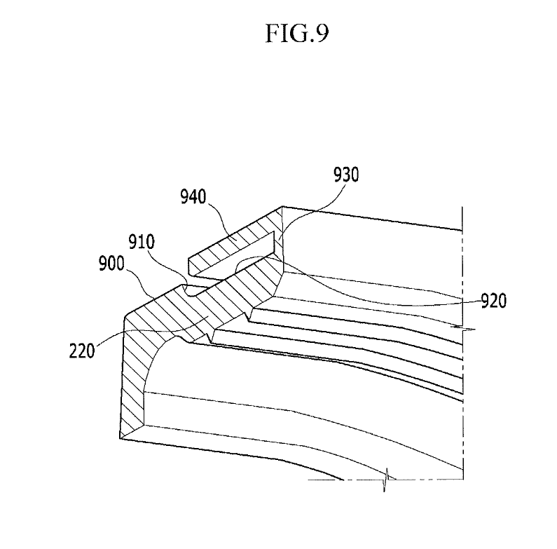

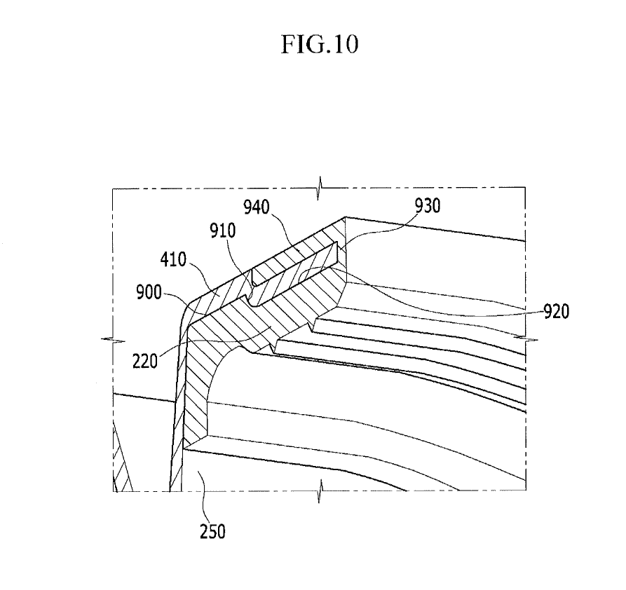

Referring to FIGS. 9 to 10, an engagement structure of the bushing 220, the boot 250, and the band 230 will be further described. FIG. 9 is a perspective cross-sectional view showing a section of a bushing on a boot unit according to various other embodiments of the present invention.

Referring to FIG. 9, the bushing 220 includes an exterior circumference that contacts an interior circumference of the large diameter portion of the boot 250, and the bushing 220 includes one side exterior circumference 900 and the other side exterior circumference 920. In FIG. 8 and FIG. 9, one side exterior circumference 900 is formed at a left side, and the other side exterior circumference 920 is formed at a right side.

A step surface 910 is formed between one side exterior circumference 900 and the other side exterior circumference 920. The step surface 910 can be readily varied to have various configurations, such as a slanted surface having a predetermined angle, a curved line surface having a predetermined curve shape, and a vertical surface having a vertical shape.

One side exterior circumference 900 and the other side exterior circumference 920 have predetermined distances from the central axis 800 and a distance between one side exterior circumference and a central axis 800 is longer than that between the other side exterior circumference 920 and the central axis 800.

Further, an end portion cover portion 930 protrudes at the other side end portion of the bushing 220 from an exterior circumference in a radial direction and an outside cover portion 940 is formed to extend to one side at one end portion of the end portion cover portion 930. One interior circumference and the other side exterior circumference 920 of the outside cover portion 940 have a predetermined distance.

The busing 220 having the above structure and the large diameter portion 410 of the boot 250 are formed, for example, by an over mold method, to be integrally combined, and the structure like FIG. 10 is completed. FIG. 10 is a cross-sectional view showing an engagement structure of a bushing and a boot of a boot unit according to various other embodiments of the present invention.

Referring to FIG. 10, a large diameter portion 410 of the boot 250 contacts one side exterior circumference 900, a step surface, the other side exterior circumference 920, and the outside cover portion 940 of the busing 220 to be integrally formed with them.

Particularly, the large diameter portion 410 of the boot 250 is safely combined or bonded with the bushing 220 through the step surface 910 and is further combined or bonded with an interior circumference of the outside cover portion 940 to prevent the separation thereof.

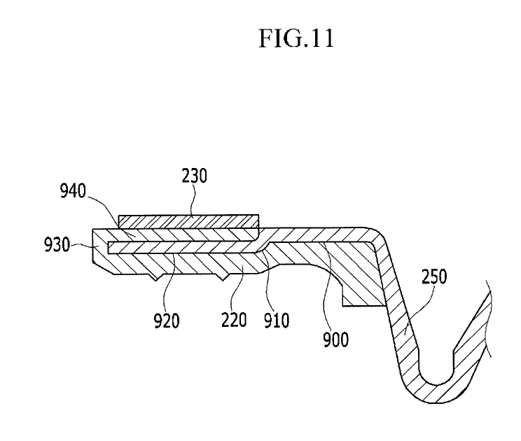

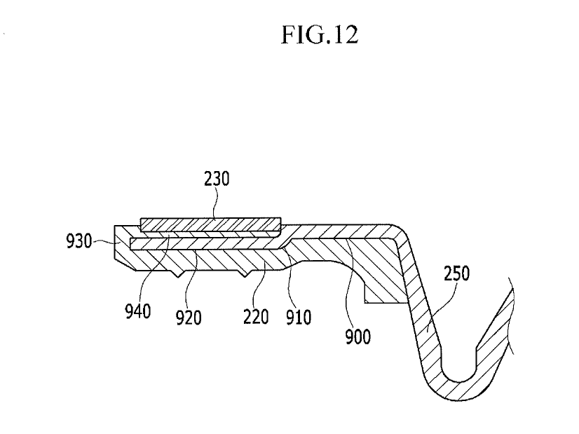

FIG. 11 is a partial cross-sectional view showing a band engaged in a boot unit according to various other embodiments of the present invention, and FIG. 12 is a partial cross-sectional view showing a band fastened on a boot unit according to various other embodiments of the present invention.

Referring to FIG. 11, the large diameter portion 410 of the boot 250 is combined or bonded with the bushing 220 by an over mold method; the band 230 is also contacted on the outside cover portion 940 of the bushing 220.

As shown in FIG. 11, the band 230 of the bushing 220 is engaged with the outside cover portion 940. As shown in FIG. 12, if the band 230 is tightened, the band 230 pressurizes the outside cover portion 940 of the bushing 220 to safely fixe the large diameter portion 410 of the boot 250. Further, the large diameter portion of the boot 250 is safely contacted on the bushing 220.

As shown in the drawings, the interior circumference of the band 230 contacts the outside cover portion of the bushing 220, wherein the boot 250 is safely fixed on the bushing 220 without direct contact with the boot 250.

For convenience in explanation and accurate definition in the appended claims, the terms “left” or “right”, “interior” or “exterior”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1-6. (canceled)

7. A method for manufacturing a boot unit, comprising:
forming a boot that includes a large diameter portion; and
integrally forming a bushing with the large diameter portion of the boot by molding the boot with the bushing using an over mold method, wherein the integrally forming a bushing includes inserting a band into the bushing.

8. The method for manufacturing a boot unit of claim 7, wherein in the integrally forming a bushing, the boot and the bushing are chemically integrally formed or bonded with each other.

9. The method for manufacturing a boot unit of claim 8, wherein in the integrally forming a bushing, a cover portion is integrally formed on the bushing in a radial direction to protect an end surface of the large diameter portion of the boot.

10. A boot unit comprising;
a bushing that includes an one side exterior circumference formed at one side thereof, an other side exterior circumference formed at the other side thereof, and a step surface formed between the one side exterior circumference and the other side exterior circumference, wherein a distance of the other side exterior circumference from a central axis is smaller than that of the one side exterior circumference from the central axis;
a boot that includes a small diameter portion formed at one side, a large diameter portion formed at the other side, a wrinkle portion formed between the small diameter portion and the large diameter portion, wherein the large diameter portion has a diameter that is larger than the small diameter portion and an interior circumference that is integrally formed with the one side exterior circumference, the step surface, and the other side exterior circumference of the bushing; and
a band that is configured to have the boot contact the bushing.

11. The boot unit of claim 10, further comprising:
an end portion cover portion that is integrally formed with an end portion of the bushing to be extended in a radial direction; and
an outside cover portion that is integrally formed with an end portion of the end portion cover portion to correspond to the other side exterior circumference of the bushing,
wherein the band contacts an exterior circumference of the outside cover portion to fix the outside cover portion on an exterior circumference of the boot and fix the boot on the other side exterior circumference of the bushing.

12. The boot unit of claim 10, wherein the bushing is molded with the large diameter portion of the boot using an over mold method, in which the large diameter portion of the boot is inserted into a mold and a molding material is injected or inserted into the mold to form the bushing.

13. The boot unit of claim 10, further comprising:
an end portion cover portion that is integrally formed with an end portion of the bushing to be extended in a radial direction; and
an outside cover portion that is integrally formed with an end portion of the end portion cover portion to correspond to the other side exterior circumference of the bushing,
wherein the band contacts an exterior circumference of the outside cover portion to fix a portion of the outside cover portion in an exterior circumference of the boot and fix the boot on the other side exterior circumference of the bushing.
